(19) United States
(12) Patent Application Publication
(10) Pub. No.: US 2009/0073089 A1
(43) Pub. Date: Mar. 19, 2009

(54) DISPLAY PANEL AND ELECTRONIC SYSTEM UTILIZING THE SAME

(75) Inventors: Chuan-Yi CHAN, Taipei City (TW); Du-Zen PENG, Jhubei City (TW)

Correspondence Address: VENABLE LLP, P.O. BOX 34385, WASHINGTON, DC, 20043-9998, US

(73) Assignee: TPO Displays Corp., Chu-Nan (TW)

(21) Appl. No.: 12/196,030

(22) Filed: Aug. 21, 2008

(30) Foreign Application Priority Data
Sep. 13, 2007 (TW) 096134228

(51) Int. Cl. G09G 3/30

(52) U.S. Cl. 345/55

(57) ABSTRACT

A display panel including a pixel unit and a scan line. The pixel unit includes a first sub-pixel, a second sub-pixel, and a third sub-pixel. The scan line is coupled to the first, the second, and the third sub-pixels and comprises a first side and a second side. The first sub-pixel is disposed on the first side and the second sub-pixel is disposed on the second side.

### BACKGROUND OF THE INVENTION

1. Field of the Invention

The invention relates to a display panel, and more particularly to a display panel comprising sub-pixels.

2. Description of the Related Art

Because cathode ray tubes (CRTs) are inexpensive and provide high definition, they are utilized extensively in televisions and computers. With technological development, new flat-panel displays are continually being developed. When a larger display panel is required, the weight of the flat-panel display does not substantially change when compared to CRT displays. Generally, flat-panel displays comprises liquid crystal displays (LCD), plasma display panels (PDP), field emission displays (FED), and electroluminescent (EL) displays.

FIG. 1 is a schematic diagram of a conventional display panel. The conventional display panel 100 comprises scan lines S₁, S₂, data lines D_{1R}˜D_{2B}, and pixel units 111˜114. The pixel units 111˜114 utilize scan lines S₁, S₂ and data lines D_{1R}˜D_{2B} to receive signal. Each of the pixel units 111˜114 comprises three sub-pixels. For example, the pixel unit 111 comprises sub-pixels R₁₁, G₁₁, and B₁₁ for respectively displaying a red color, a green color, and a blue color. When the brightness of the sub-pixels R₁₁, G₁₁, and B₁₁ is controlled, the pixel unit 111 can display the desired color.

The display panel 100 utilizes a power line to provide a power signal PVDD to each sub-pixel. Since the power signal PVDD can carries large current, the width of the power line is larger than other signal lines during a layout process. Thus, the aperture ratio of the display panel 100 is reduced.

### BRIEF SUMMARY OF THE INVENTION

Display panels are provided. An exemplary embodiment of a display panel comprises a pixel unit and a scan line. The pixel unit comprises a first sub-pixel, a second sub-pixel, and a third sub-pixel. The scan line is coupled to the first, the second, and the third sub-pixels and comprises a first side and a second side. The first sub-pixel is disposed on the first side and the second sub-pixel is disposed on the second side.

Electronic systems are also provided. An exemplary embodiment of an electronic system comprises a voltage converter and a display panel. The voltage converter transforms an external voltage into an operating voltage. The display panel displays a frame according to the operating voltage and comprises a pixel unit and a scan line. The pixel unit comprises a first sub-pixel, a second sub-pixel, and a third sub-pixel. The scan line is coupled to the first, the second, and the third sub-pixels and comprises a first side and a second side. The first sub-pixel is disposed on the first side and the second sub-pixel is disposed on the second side.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of a conventional display panel;

FIG. 2 is a schematic diagram of an exemplary embodiment of an electronic system;

FIG. 3 is a schematic diagram of an exemplary embodiment of a display panel;

FIG. 4 is a schematic diagram of an exemplary embodiment of the pixel unit;

FIG. 5 is a schematic diagram of another exemplary embodiment of the pixel unit;

FIG. 6 is a schematic diagram of another exemplary embodiment of the pixel unit; and

FIG. 7 is a schematic diagram of another exemplary embodiment of the pixel unit.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

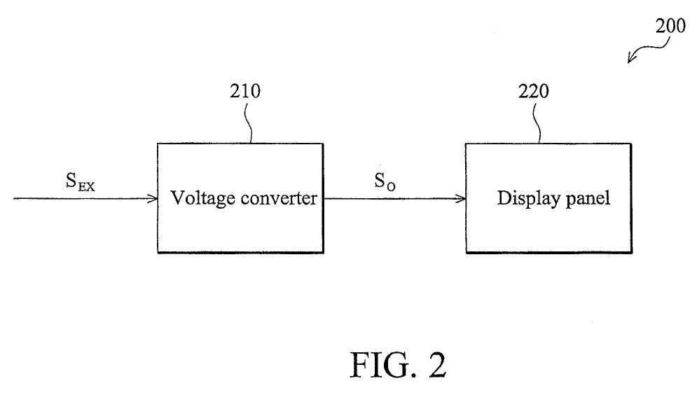

FIG. 2 is a schematic diagram of an exemplary embodiment of an electronic system. The electronic system 200 is a personal digital assistant (PDA), a cellular phone, a digital camera, a television, a global positioning system (GPS), a car display, an avionics display, a digital photo frame, a notebook computer (NB), or a personal computer (PC). As shown in FIG. 2, the electronic system 200 comprises a voltage converter 210 and a display panel 220. The voltage converter 210 transmits an external voltage S_{EX} into an operating voltage S_{O}. For example, if the type of the external voltage S_{EX} is an alternating current (AC) type, the voltage converter 210 transforms the type of the external voltage S_{EX} from the AC type to a direct current (DC) type. If the type of the external voltage S_{EX} is the DC type, the voltage converter 210 transforms the level of the external voltage S_{EX}. The display panel 220 displays a frame according to the operating voltage S_{O}.

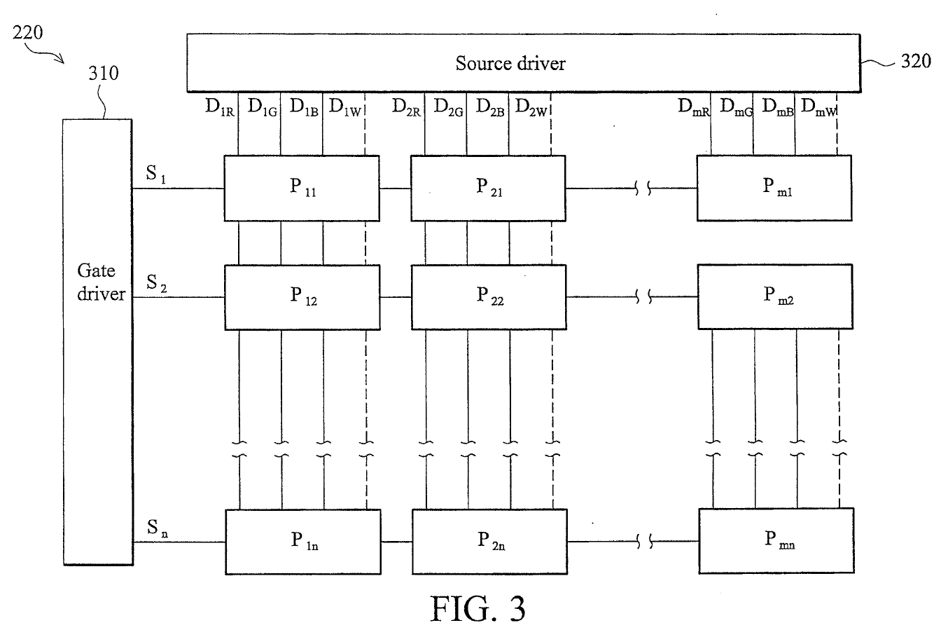

FIG. 3 is a schematic diagram of an exemplary embodiment of a display panel. The display panel 220 comprises pixel units P₁₁˜Pₘₙ and scan lines S₁˜Sₙ. The scan lines S₁˜Sₙ are coupled to the pixel units P₁₁˜Pₘₙ for transmitting scan signals generated by a gate driver 310 to the pixel units P₁₁˜Pₘₙ. Additionally, the display panel 220 further comprises data lines D_{1R}˜D_{mW} for transmitting data signals generated by a source driver 320 to the pixel units P₁₁˜Pₘₙ.

The number of the data lines is determined by the number of the sub-pixels of one pixel unit. If each pixel unit comprises three sub-pixels, the pixel unit is coupled to three data lines. Taking the pixel unit P₁₁ as an example, if the pixel unit P₁₁ comprises three sub-pixels, the pixel unit P₁₁ is coupled to data lines D_{1R}, D_{1G}, and D_{1B}. If the pixel unit P₁₁ comprises four sub-pixels, the pixel unit P₁₁ is coupled to data lines D_{1R}, D_{1G}, D_{1B}, and D_{1W}. Since the structures of the pixel units P₁₁˜Pₘₙ are the same, the pixel unit P₁₁ is given as an example.

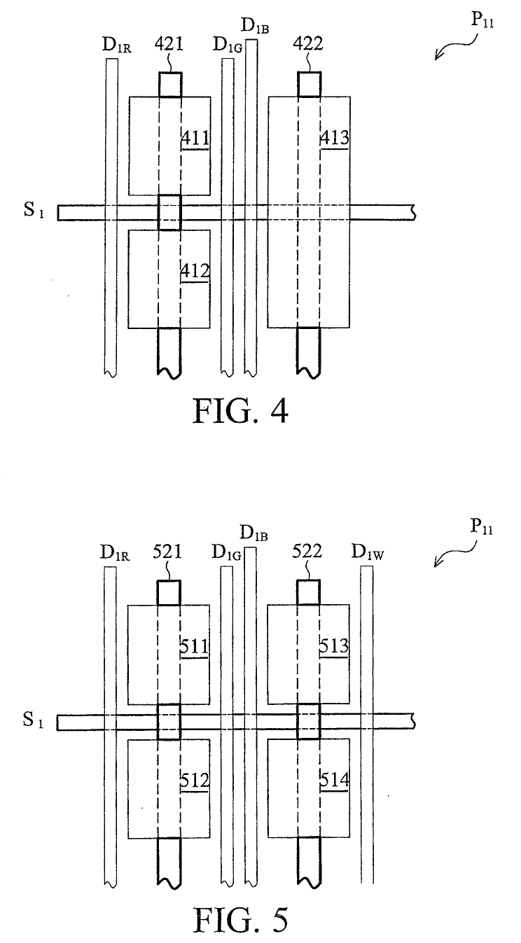

FIG. 4 is a schematic diagram of an exemplary embodiment of the pixel unit. The pixel unit P₁₁ comprises sub-pixels 411˜413 displaying a red color, a green color, and a blue color, respectively. The sub-pixels 411 and 412 respectively dispose on two sides of the scan line S₁. The sub-pixel 413 passes across the scan line S₁. The measure of a luminosity area of the sub-pixel 411 is the same as or is different from the measure of a luminosity area of the sub-pixel 412. In this embodiment, the measure of a luminosity area of the sub-pixel 411 is the same as the measure of a luminosity area of the sub-pixel 412. The measure of a luminosity area of the sub-pixel 413 exceeds the measure of a luminosity area of the sub-pixel 411.

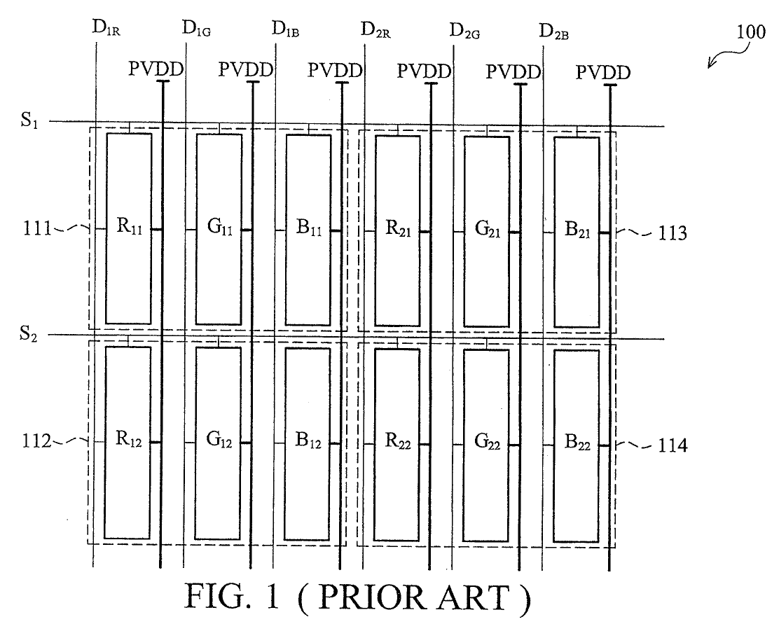

If the location of the scan line S₁ is adjusted, the measures of the luminosity areas of the sub-pixels 411 and 412 are elastically controlled. Thus, the aperture ratio of the display panel is increased. For example, if the scan line moves to the sub-pixel 411, the measure of the luminosity area of the sub-pixel 411 is reduced and the measure of a luminosity area of the sub-pixel 412 is increased. Referring to FIG. 1, since the scan lines S₁ and S₂ are located on the upper side of the corresponding sub-pixels, the measures of the luminosity areas of the sub-pixels are limited by the location of the scan lines S₁ and S₂. For example, since the scan line S₁ is located on the upper side of the sub-pixels R₁₁, G₁₁, and B₁₁, the measures of the luminosity areas of the sub-pixels R₁₁, G₁₁, and B₁₁ are limited by the location of the scan line S₁. The locations of the scan lines of the display panel 200 are arbitrarily adjusted such that the measures of the luminosity areas of the sub-pixels are elastically controlled. Thus, the aperture ratio of the display panel 200 is increased.

Since the layer of the scan line S₁ is different from the layer of the sub-pixel 413, the sub-pixel 413 can pass across the scan line S₁. Additionally, the data line D_{1R} is disposed on the left-sides of the sub-pixels 411 and 412. The data line D_{1G} is disposed on the right-sides of the sub-pixels 411 and 412. The data line D_{1B} is disposed on the left-side of the sub-pixel 413. A power line 421 is disposed between the data lines D_{1R} and D_{1G} and passes across the sub-pixels 411 and 412 for providing a power signal PVDD to the sub-pixels 411 and 412. A power line 422 passes across the sub-pixel 413 for providing the power signal PVDD to the sub-pixel 413.

FIG. 5 is a schematic diagram of another exemplary embodiment of the pixel unit. The pixel unit P₁₁ comprises sub-pixels 511˜514. The sub-pixels 511˜514 display a red color, a green color, a blue color, and a white color. The sub-pixels 511 and 513 are disposed on the upper side of the scan line S₁. The sub-pixels 512 and 514 are disposed on the lower side of the scan line S₁. In this embodiment, the measures of the luminosity areas of the sub-pixels 511-514 are the same.

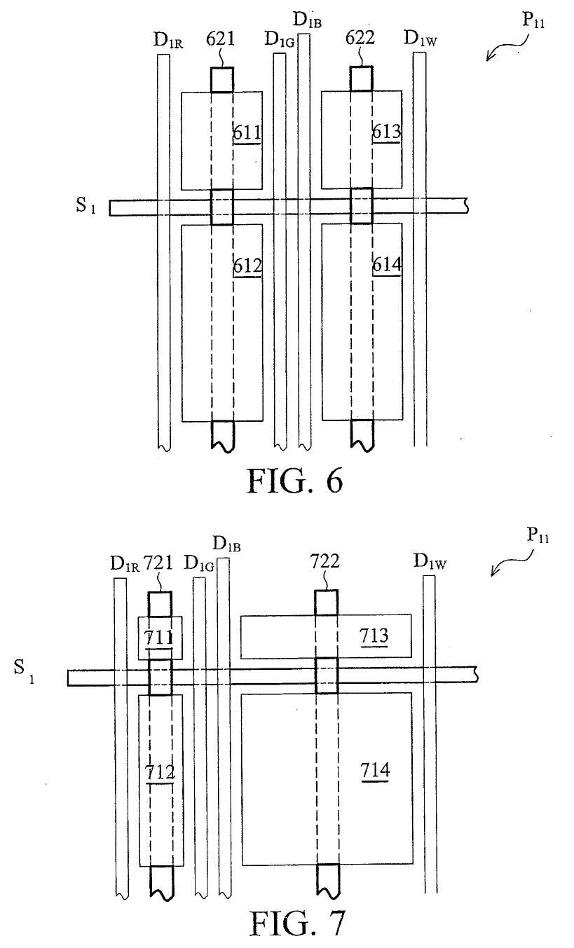

FIG. 6 is a schematic diagram of another exemplary embodiment of the pixel unit. FIG. 6 is similar to FIG. 5 with the exception that the measures of the luminosity areas of the sub-pixels 611 and 613 are the same, and the measures of the luminosity areas of the sub-pixels 612 and 614 are the same. Since the location of each scan line is elastically adjusted, the measures of the luminosity areas of the sub-pixels 612 and 614 are larger.

FIG. 7 is a schematic diagram of another exemplary embodiment of the pixel unit. FIG. 7 is similar to FIG. 5 with the exception that the locations of each scan line and each data line are elastically adjusted. Thus, the measures of the luminosity areas of the sub-pixels 711˜714 are different. For example, if the scan line S₁ moves to sub-pixels 711 and 713, the measures of the luminosity areas of the sub-pixels 711 and 713 are reduced, and the measures of the luminosity areas of the sub-pixels 712 and 714 are increased. When the data line D_{1W} moves to the right-sides of sub-pixels 713 and 714, the measures of the luminosity areas of the sub-pixels 713 and 714 are increased. Thus, the measures of the luminosity areas of the sub-pixels 711-714 are different.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display panel, comprising:
a pixel unit comprising a first sub-pixel, a second sub-pixel, and a third sub-pixel; and
a scan line coupled to the first, the second, and the third sub-pixels and comprising a first side and a second side, wherein the first sub-pixel is disposed on the first side and the second sub-pixel is disposed on the second side.

2. The display panel as claimed in claim 1, further comprising:
a first data line transmitting a first data signal to the first sub-pixel and disposed on a left-side of the first sub-pixel and a left-side of the second sub-pixel;
a second data line transmitting a second data signal to the second sub-pixel and disposed on a right-side of the first sub-pixel and a right-side of the second sub-pixel; and
a first power line disposed between the first and the second data lines for providing a power signal to the first and the second sub-pixels.

3. The display panel as claimed in claim 2, wherein the first sub-pixel displays a red color, the second sub-pixel displays a green color, and the third sub-pixel displays a blue color.

4. The display panel as claimed in claim 3, wherein the third sub-pixel across passes across the scan line.

5. The display panel as claimed in claim 4, wherein the measure of a luminosity area of the first sub-pixel is the same as the measure of a luminosity area of the second sub-pixel, and the measure of a luminosity area of the first sub-pixel is different from the measure of a luminosity area of the third sub-pixel.

6. The display panel as claimed in claim 3, wherein the third sub-pixel is disposed on the first side.

7. The display panel as claimed in claim 6, wherein the pixel unit further comprises a fourth sub-pixel disposed on the second side.

8. The display panel as claimed in claim 7, further comprising:
a third data line transmitting a third data signal to the third sub-pixel and disposed between the first and the third sub-pixels; and
a fourth data line transmitting a fourth data signal to the fourth sub-pixel and disposed between the third and the fourth sub-pixels.

9. The display panel as claimed in claim 8, further comprising a second power line disposed between the third and the fourth data lines for providing the power signal to the third and the fourth sub-pixels.

10. The display panel as claimed in claim 9, wherein the fourth sub-pixel displays a white color.

11. The display panel as claimed in claim 10, wherein the measures of the luminosity areas of the first sub-pixel, the second sub-pixel, and the third sub-pixel are the same as the measure of a luminosity area of the fourth sub-pixel.

12. The display panel as claimed in claim 10, wherein the measure of the luminosity area of the first sub-pixel is the same as the measure of the luminosity area of the third sub-pixel, the measure of the luminosity area of the second sub-pixel is the same as the measure of a luminosity area of the fourth sub-pixel, and the measure of the luminosity areas of the second sub-pixel and the fourth sub-pixel are larger than the measure of the luminosity areas of the first sub-pixel and the third sub-pixel.

13. The display panel as claimed in claim 10, wherein the measures of the luminosity areas of the first sub-pixel, the second sub-pixel, and the third sub-pixel are different from the measure of a luminosity area of the fourth sub-pixel.

14. An electronic system, comprising:
a voltage converter transforming an external voltage into an operating voltage; and
a display panel displaying a frame according to the operating voltage and comprising:
a pixel unit comprising a first sub-pixel, a second sub-pixel, and a third sub-pixel; and
a scan line coupled to the first, the second, and the third sub-pixels and comprising a first side and a second side, wherein the first sub-pixel is disposed on the first side and the second sub-pixel is disposed on the second side.

15. The display panel as claimed in claim 14, wherein the display panel further comprises:
a first data line transmitting a first data signal to the first sub-pixel and disposed on a left-side of the first sub-pixel and a left-side of the second sub-pixel;
a second data line transmitting a second data signal to the second sub-pixel and disposed on a right-side of the first sub-pixel and a right-side of the second sub-pixel; and
a first power line disposed between the first and the second data lines for providing a power signal to the first and the second sub-pixels.

16. The display panel as claimed in claim 15, wherein the first sub-pixel displays a red color, the second sub-pixel displays a green color, and the third sub-pixel displays a blue color.

17. The display panel as claimed in claim 16, wherein the third sub-pixel across passes across the scan line.

18. The display panel as claimed in claim 17, wherein the measure of a luminosity area of the first sub-pixel is the same as the measure of a luminosity area of the second sub-pixel, and the measure of a luminosity area of the first sub-pixel is different from the measure of a luminosity area of the third sub-pixel.

19. The display panel as claimed in claim 16, wherein the third sub-pixel is disposed on the first side.

20. The display panel as claimed in claim 19, wherein the electronic system is a personal digital assistant (PDA), a cellular phone, a digital camera, a television, a global positioning system (GPS), a car display, an avionics display, a digital photo frame, a notebook computer (NB), or a personal computer (PC).
